(19) United States
(12) Patent Application Publication
(10) Pub. No.: US 2015/0167889 A1
(43) Pub. Date: Jun. 18, 2015

(54) TRANSPORT FRAME FOR ENERGY CHAINS

(71) Applicant: igus GmbH, Koeln (DE)

(72) Inventor: Christian Stremlau, Troisdorf (DE)

(21) Appl. No.: 14/395,109

(22) PCT Filed: Apr. 16, 2013
(86) PCT No.: PCT/EP2013/057926

§ 371 Date: Feb. 24, 2015

(30) Foreign Application Priority Data
Apr. 20, 2012 (DE) 20 2012 003 941.5

(51) Int. Cl. F16M 11/04; F16M 11/42

(52) U.S. Cl. CPC F16M 11/045; F16M 11/42; F16M 11/046

(57) ABSTRACT

The invention relates to a transport and mounting frame for at least one supply line or line-guiding device, comprising at least one or more supply lines, wherein the frame comprises a retaining device for retaining the line guide in a spatially defined position, and wherein the frame preferably comprises a docking device for the positionally defined docking of the frame to a machine under releasable fixing to said machine, to which machine the line-guiding device is to be fastened as part of the machine. In accordance with the invention, the retaining device is attached to the frame in such a way that the position of the retaining device relative to the frame can be changed, so that the line guide can be arranged in several positions, and fastening means are provided for fixing the retaining device and thus the line-guiding device in the several positions.

The invention relates to a transport and mounting frame for supply lines or line-guiding devices, comprising at least one or more supply lines, wherein the frame comprises a retaining device for retaining the line and/or line guide in a spatially defined position, and preferably comprising a docking device for the positionally defined docking of the frame to a machine, to which machine the supply line and/or line guide is to be fastened as part of the machine. The invention further relates to a method for mounting supply lines or line-guiding devices with at least one or several supply lines.

The supply line and/or line-guiding device which is provided with one or several supply lines and which is to be fastened to the respective machine is spatially preconfigured by means of a generic transport and mounting frame in order to enable mounting on the machine in a manner that is simple and custom-fit. The supply line or line guide is then spatially arranged on the frame in the manner that the connecting parts of the lines and/or terminal clamping parts of the line guides are already arranged in their target position, as are required for the fastening of said parts on the machine.

In the case of current mounting frames, an on-site measurement is carried out at the installation location of the machine with respect to the target position of the connecting devices or terminal clamping parts of the line guides, and also the target position of the lines and line guide for their mounting. The on-site measurement is usually determined by means of a provisional frame made of a lightweight material such as wood in order to determine at first the target position of the connecting elements and terminal clamping members, wherein a transport and mounting frame with sufficient carrying capability and stability with respect to the supply lines and line guide to be arranged is subsequently to be produced on the basis of the provisional frame. The production of the actual transport and mounting frame occurs in a separate workshop as a welded construction. Subsequently, the proper arrangement and spatial configuration of the frame must be checked on-site on the machine, which is then optionally corrected. Finally, the frame is equipped at the location of the manufacturer or supplier with the supply line or line guide and is then transported for mounting to the installation location of the machine. This sequence of work is very laborious.

It is therefore the object of providing a transport and mounting frame for supply lines or line guides with such lines to be mounted on machines, which frame facilitates the work flow from project planning of the supply lines and the line guide up to their mounting on the respective machine.

This object is achieved by a transport and mounting frame according to claim 1, wherein the retaining device is attached to the frame in such a way that the position of the retaining device relative to the frame can be changed, so that the supply line or line guide can be arranged in several positions relative to the frame and can thus be aligned with respect to its target position for mounting. Furthermore, locking means are provided for fixing the retaining device with the supply line (hereinafter referred to as “the line”) and the line-guiding device (hereinafter “the line guide”) arranged thereon in several different positions. The positionally variable retaining device can thus be adjusted on-site on the machine and fixed in this position to the frame, so that the frame which is thus adjusted to the respective machine configuration can be equipped directly with the respective supply line or a line guide at a different location, e.g. at the location of the respective manufacturer or supplier. The equipped frame can then dock onto the machine by means of the docking device in order to fasten the supply line or line guide thereto. The project planning effort is thus reduced to a considerable extent. Furthermore, a more precise mounting of the supply line or line guide on the machine is thus also enabled in individual cases because an optional readjustment of the holding device on-site is possible, in combination with local fixing of the retaining device in the readjusted position. This is not possible in conventional welded constructions of the frame. A further important advantage of the frame in accordance with the invention is its reusability also on differently configured machines, in that the retaining device is brought to different target position or the frame components are assembled into a new frame that is configured differently, which is not possible in the case of conventional welded constructions which are tailor-made products made to customer's specifications.

The object is further achieved by a method in which a transport and mounting frame in accordance with the invention is provided, and the supply line and the line-guiding device with at least one supply line is transported and/or mounted on the machine by means of the transport and mounting frame in accordance with the invention. The retaining device for the supply line or line-guiding device is attached to the frame in a positionally variable manner relative thereto, wherein the supply line or a line guide can be arranged in several positions relative to the frame and can thus be aligned with respect to its target position for mounting, and the supply line or line-guiding device is aligned in its target position on the frame in accordance with the method by changing the position of the positionally variable components of the retaining device, wherein the alignment of the components of the retaining device occurs before or after, or in combination before or after, fastening of the supply line or line guide to the retaining device. “Target position” is the position or spatial configuration of the supply line/line guide which is to be assumed by them for the preferably custom-fit mounting on the machine. Furthermore, locking means are provided for locking the retaining device with the supply line or line guide arranged thereon in several different positions, wherein the retaining device is fixed in accordance with the method in one of the several positions by means of the locking means in a selected one of several different positions, preferably in a position which corresponds to the target position or comes closest to said position among the selectable positions. The positionally variable retaining device is adjusted on site on the machine with respect to its position and fixed in this position to the frame, so that the frame adjusted in this manner to the respective machine configuration is directly equipped with the respective supply line or line guide at a different location, e.g. at the location of the respective manufacturer or supplier. The equipped frame is then docked onto the machine by means of the docking device in order to fasten the supply line or line guide to said machine. The project planning effort is thus reduced considerably. Reference is hereby made to the further advantages mentioned with respect to the use of the frame, especially that a more precise mounting of the supply line or line guide on the machine is enabled, wherein a readjustment of the retaining device can optionally be made on site, in combination with local fixing of the retaining device in the readjusted position. The method comprises the reuse of the frame in accordance with the invention for the transport or for mounting a supply line or line guide on a machine that is configured in a different way, in that the retaining device is brought to a different target position or the frame components are assembled into a new frame that is configured differently.

It is understood that the provided functionalities and possibilities for handling the frame can generally be made by the method in accordance with the invention. It is understood that in general the frame in accordance with the invention or the machine described within the scope of the invention can be handled or used within the method in accordance with the invention.

Preferred embodiments are provided in the sub-claims.

At least two retaining devices for the at least one line or line guide are preferably provided on the frame, namely for the two respective end regions thereof. Two regions, especially the end regions, of the line or line guide are retained in accordance with the method on the two retaining devices. The two retaining regions can generally be arranged in a similar way and especially identical with respect to their functionality (especially the possibility for adjusting the position), so that the respective configurations can respectively relate to both retaining devices. Both retaining devices can optionally also be arranged in a different way, e.g. one of the degrees of freedom in the movement can be missing in a retaining device, especially in the docking direction (Z direction).

The retaining device is positionally variable in a continuous fashion in an especially preferred way and can be locked in its position in a positionally variable way and in continuously selectable positions with retained supply line or line guide by means of a locking means. In accordance with the method, the retaining device is changed in its position in a continuous fashion and is locked in continuously selectable positions with retained supply line or line guide by means of a locking means. An independent retaining device is associated in an especially preferred way with each of the two end regions of the supply line or line guide, by means of which the respective end region is positionally variable or changed in its position in a continuous fashion independently from another end region of the supply line or line guide, for the purpose of transferring the line or line guide to its target position. The aforementioned statements respectively relate to a change in position of the retaining devices relative to the frame, i.e. also to a frame which is docked onto the machine and is fixed with respect to its position.

Reference is made in general below to the retaining of the line guide, which optionally also relates to a respective retaining of a supply line, unless the context discloses otherwise.

The retaining device determines the region of the line or line guide releasably arranged thereon, preferably in at least two or more preferably in three spatial directions, i.e. it is thus fixed in its position on all sides. A suitable clip can be provided for this purpose for example.

The line guide to be inserted can comprise one or several supply lines and can enable a spatially defined curvature of the accommodated supply line(s) on the machine or preferably a spatially variable arrangement of the respective supply line(s) on the machine. The line guide can thus optionally be arranged in a rigid fashion, preferably it is arranged in a spatially flexible way. The supply line can consist of a plurality of assembled members or comprise deformable or positionally variable regions between the individual members for this purpose. The respective member is thus preferably assumed as a substantially rigid component, and optionally the members per se can also be arranged in a deformable fashion. The deformation shall respectively be understood with respect to a movement of components or devices of the machine relative to each other during operation of the machine. The line guide can also be arranged in the manner of a link chain, e.g. with links connected in an articulated manner with link plates and cross members, by means of ball joints or members connected to other multi-axial joints, or also in form of guides with strip-like connecting elements, wherein the members are releasably or non-releasably arranged on an elongated (e.g. strip-like) carrier element. The guides can optionally also be arranged in integral fashion with two rigid member regions and comparatively flexible connecting regions, e.g. in form of slotted tubes, hoses or the like. Line guides as described above are preferred, but the invention is not limited to them. The line-guiding device (hereinafter: “the line guide”) respectively comprises at least one or several continuous longitudinal channels for accommodating and guiding one or several respective supply lines. Embodiments within the scope of the invention in relation to supply lines comprise free lines and preferably include such in line guides.

The two end regions of the line guide are preferably provided with end fastening members or end fastening devices which are used for fastening the line guide to the machine. The same can be provided for the supply lines, which are provided and mounted on the machine without a line guide. The end fastening regions are mostly fixed or to be fixed to parts of the machine which can be dismountable from the machine.

The supply line can be used for guiding random media such as in form of electricity cables, hoses, and especially for guiding fluid (liquid or gaseous) media or the like.

The supply lines can generally be provided with at least substantially the length of the line guide, apart from the connecting regions which are arranged outside of the same. The supply lines can optionally also be provided with a considerably longer length and only be arranged partly within the line guide.

The docking device is preferably arranged in such a way that it allows fastening of the frame to the machine under spatial alignment of them with respect to each other. It is optionally also possible to provide a spatial fastening in two spatial directions under loading of one degree of freedom in another spatial direction. The docking device can comprise one or several flanges, which are or can be fastened to a fastening region of the machine, or as another receiver or fastening means for a corresponding fastening means of the machine such as in a fastening projection or the like. The fastening of the frame to the machine preferably occurs in a releasable fashion. The retaining of the supply line or line guide on the frame preferably also occurs in a releasable manner, so that the frame can be removed separately from the machine after coupling the supply line or line guide to the machine.

One or both retaining devices for the end regions of the line guide are positionally variable in an especially preferred way in two mutually independent spatial directions (the X and Y direction) and can be fixed in a freely selected position, wherein said directions are arranged transversely and perpendicularly to the docking direction (Z direction) of the frame on the machine. The aforementioned change in position and fixing is respectively carried out in accordance with the method. Preferably, the two end regions of the respective line guide are associated with one retaining device each, which are positionally variable in at least two directions (X direction, Y direction) relative to the frame, and positionally variable independently from each other in an especially preferred manner, and can be fixed in a freely selected position. In accordance with the method, the two end regions of the respective line guide are associated with one retaining device each, which are positionally variable in at least two directions (X direction, Y direction) relative to the frame, and are positionally variable independently from each other in an especially preferred manner, and are fixed in a freely selected position. This allows an alignment of the end regions of the line guide (and accordingly also the supply line) on the frame with respect to their target position during their fastening to the machine.

In an especially preferred manner, at least one or both of the retaining devices of the line guide end regions is positionally variable or adjusted in three independent spatial directions (X, Y and Z direction), and can or will be positionally fixed in a freely selected position with respect to each of these spatial directions. This is preferably provided for both of the retaining devices of the two end regions of the line guide or line.

The aforementioned spatial directions X and Y or the X and Y and Z direction respectively form a two-dimensional or three-dimensional coordinate system by spanning an area or a plane or a space, preferably a Cartesian coordinate system, optionally also a curvilinear or curvilinear-orthogonal coordinate system. In the case of a curvilinear-orthogonal coordinate system, a change in the position of the retaining device can be realised for example by a pivoting or twisting means. The change in the position of the retaining device can occur or is carried out in the respective directions independently from each other, e.g. by independent carriage guides. Changes in position coupled in two or three spatial directions can be enabled or are performed, e.g. by using pivotably or rotatably mounted retaining devices, including ball-bearing retaining devices.

The retaining device is thus respectively preferably positionally variable in a translatory manner irrespective of one another, or its target position is positionally changed for the alignment of the line or the line guide for the transfer of the same, e.g. by means of suitable carriage guides. Different carriage guides or translatory displacement devices can respectively be provided or actuated in the X and Y direction (and optionally in the Z direction). This applies in an especially preferred way for both retaining devices, which retain the end regions of the line guide independently from each other.

The positional variability of the respective retaining device is continuously possible or is performed in a respectively preferred manner, which applies to all embodiments of the invention.

The respective devices for changing the position of the retaining devices such as carriages etc are preferably supported by pillars, and they can optionally be attached alternatively or additionally in a direct fashion to a travelling carriage or base plate of the frame.

As a result of the frame in accordance with the invention, the two end regions of the supply line or line guide, or generally preferably all coupling regions of the line or guide, can precisely be aligned and fixed in this target position (e.g. with precision in the millimetre range) with respect to the associated fastening and coupling regions of the machine, or are aligned and fixed in said target position, for the transport and mounting of the line or guide.

The invention further comprises a frame as described in accordance with the invention, comprising at least one supply line and/or line guide having one or several supply lines, wherein one or all of the supply lines are provided with connecting devices for connecting the same to the respective machine. The coupling of the connecting devices of the supply lines to the machine allows transferring media such as electric current, fluid or the like. This relates to all embodiments of the frame and implementations of the method in accordance with the invention. The invention further comprises a frame with at least one supply line or line guide comprising one or several supply lines, wherein the frame does not comprise a consumer and/or supplier with respect to the medium conducted through the supply line, which also applies to carrying out the method.

The invention further comprises a frame as described in accordance with the invention, comprising at least one line guide having one or several supply lines, end fastening parts of the line-guiding device for fastening to the machine, preferably at both ends regions of the line guide, which can also be used in accordance with the method. This applies especially in combination with connecting parts attached to the at least one supply line or all supply lines. The associated machine parts can also already be fixed to at least one or all end fastening part of the line guide, so that the machine parts can be or are fixed to the machine, which is often simpler due to the accessibility and/or stability of the same on the machine.

The invention comprises a transport and mounting frame in accordance with the invention with a supply line or line-guiding device having a supply line, wherein a supplier and/or a consumer with respect to the medium conducted by the supply line is not arranged on the transport and mounting frame (i.e. especially not directly on the same), therefore with respect to supplier and/or consumer to which the supply line is to be connected for the operation of the machine. The supplier and/or consumer is respectively a part of the machine and can be provided on the machine during mounting of the frame on the machine. The frame is therefore not used for retaining the machine and is preferably not part of the machine in the relevant operation, but it is used for the transport and mounting of the at least one supply line or line-guiding device with a supply line. This type of frame can be used and manipulated in accordance with the method. The frame can be arranged to be free-standing independent of the machine or can be arranged in a freely installable manner, preferably also with retained line or line guide, especially with line or line guide disposed in its target position.

The machine thus mostly or generally comprises an installation and/or retaining device which is independent of the transport and mounting frame for the spatial position and installation of the machine, e.g. on a machine table, a machine foundation or base, or the like.

The transport mounting frame thus mostly or generally comprises an installation and/or retaining device which is independent of the transport and mounting frame for the spatial installation of the frame, e.g. one or several feet, a travelling carriage or the like.

Preferably, both ends of the supply line are fixed to the machine or can be fixed to the machine for the operation thereof, especially without arrangement of the frame on the machine for the operation of said machine. The invention further relates to a movable transport apparatus which can be displaceable in particular, e.g. a movable table or container which comprises an assembly, from which the frame in accordance with the invention can be assembled. Said assembly preferably comprises a number of components that is larger than the number necessary for producing a specific frame in accordance with the invention, so that several different frames can be assembled by means of the assembly. A frame can be assembled in this manner which is adapted to the respective requirements by providing the equipped transport container on site on the respective machine for the purpose of arranging the respective supply line or line guide in its target position.

The group of components of the transport apparatus can especially comprise the following components of a frame in accordance with the invention:
a running gear (preferably comprising two independent travelling carriages);
a docking device;
at least one pillar (that can be arranged vertically), preferably two to four or more pillars;
at least one or preferably two to ten struts or cross members which can be arranged transversely to the pillars and can be fastened thereto, e.g. for connecting the pillars and/or for fastening a holding device;
a retaining device for its end regions with at least one supply line or line guide;
at least one means for continuous change in position and fixing by means of a retaining means, preferably two such means for continuous bearing and fixing of two retaining means.

On the basis of the above assembly, the group of components can comprise independently from each other:
at least two pillars (that can be arranged vertically);
at least four struts or cross members, e.g. up to 20 struts or cross members, which can be arranged transversely to the pillars and can be fixed thereto, e.g. for connecting the pillars and/or for fastening a retaining device;
at least two retaining devices for the end regions of the at least one supply line or a line guide;
at least one means for the continuous change in position and fixing of the at least one retaining device, preferably at least two such devices for the continuous bearing and fixing of two retaining means.

At least four pillars are preferably provided.

Two or more of the pillars are preferably telescopic.

At least two retaining devices are preferably provided.

Several extension elements for pillars are preferably provided.

Several extension elements for struts and/or cross members are preferably provided.

At least two or at least four of the struts and cross members are preferably telescopic or variable in length.

More than four coupling elements for coupling the extension elements to the respective pillars and cross members are preferably provided, e.g. in form of corner connectors, T-connectors, cross connectors and the like.

At least two X and Y carriages are preferably provided, by means of which the retaining devices can be changed in their position in two spatial directions independently from each other and in a continuous fashion on the frame, wherein they are each associated with a retaining device.

At least one X, Y and Z carriage is preferably provided, by means of which a retaining device can be changed in its position in three spatial directions independently and in a continuous fashion on the frame.

The pillars and struts or cross members preferably have the same cross-section, so that the extension elements or coupling elements can be coupled selectively to a pillar or strut or cross member.

At least one supply line or a line guide with supply line is preferably further comprised for the spatially defined retaining on the frame or its retaining device.

The invention further comprises a frame with supply lines or line guides having at least one or several supply lines, and with connecting devices of one or several supply lines, wherein the connecting device of at least one or several supply lines is connected to a connecting part of the respective machine. The machine connection part is thus adjusted to the respective machine and is a part of the same.

In particular, the invention comprises a frame, as described with respect to all embodiments of the invention, comprising at least one supply line or line guide having at least one or several supply lines, wherein at least one or all of the supply lines are adjusted spatially in their position with respect to an associated machine, wherein the supply line(s) are situated in their target position for direct coupling to the machine. The supply lines preferably comprise the connecting devices for coupling to the machine in their end regions. The frame can further respectively comprise a protective device which protects the regions of the supply lines from external influences and/or foreign substances, e.g. in form of a cover cap or a terminal box.

The invention further comprises a method for mounting a supply line and/or line-guiding device with at least one supply line in a machine, by means of a frame in accordance with the invention, especially a frame according to one of the claims 1 to 20.

The invention comprises a method in particular for mounting a supply line and/or a line-guiding device having at least one supply line on a machine, wherein the supply line and/or line-guiding device is provided with at least one supply line on a frame in accordance with the invention arranged in a spatially defined position, wherein subsequently the frame is releasably fastened to the machine by means of the docking device, the at least one supply line is coupled to the machine, preferably the consumer and/or supplier of the machine corresponding with the supply line, and the frame is dismounted from the supply line and the machine when the supply line is continuously coupled to the machine.

The coupling of the supply line to the corresponding consumer and/or supplier is a coupling which allows the transfer of medium through the supply line.

Instead of a releasable fastening of the frame to the machine, the frame can generally optionally also be fixed within the scope of the invention in an alternative fashion to a device which is arranged in a preferably stationary manner relative to the machine, e.g. a scaffold or part of a machine shop erected adjacent to the machine, a machine retainer or foundation or base or the like, in so far as such a connection allows a preferably media-transferring coupling of the supply line to the consumer and/or supplier corresponding with the supply line. A more direct fastening of the frame to the machine occurs preferably however.

The transport and mounting frame can thus configure the at least one supply line with the line connections in a spatial manner and to the frame in such a way that the spatial arrangement of the connections of the supply line is adjusted and congruent with the spatial arrangement of the coupling devices of the consumer and/or supplier of the machine, so that after the arrangement or fastening of the frame to the machine by means of the docking device the supply line can be connected or coupled in a direct fashion and preferably in a media-transferring way (with respect to the medium to be conducted by the supply line) to the supplier and/or consumer. This can optionally occur apart from a fine adjustment of the connections of the supply line, wherein the fine adjustment can generally amount to 5 to 10 times the connection diameter or optionally more, preferably 3 to 4 times or up to 1 to 2 times of the connection diameter (the connection diameter as the diameter of the connection such as in particular the connection flange of the respective line end), preferably less than the single connection diameter or at least substantially in a custom-fit way.

The frame in accordance with the invention allows reuse in order to spatially fasten different spatially configured or arranged supply lines by means of the same frame, thus allowing mounting on a machine, wherein they can be different supply lines and/or identical supply lines in different spatial configuration, i.e. in different spatial arrangement (i.e. a further supply line adjacent to a first supply line). “Reuse” shall mean here that only releasable connections of parts of the frame are to be released in order to change the position of frame parts or frame devices such as retaining devices for the supply lines with respect to each other. The retaining device of the frame can be brought to a different spatial position for at least one further supply device relative to the frame after the dismounting of the frame from the machine, so that the further supply line retained on the retaining device is arranged in a different position than the first supply line coupled previously by means of the same frame to the machine, and the retaining device in said other position is fixed by means of the fixing means for fixing the retaining device.

The invention will be described below by reference to embodiments shown in the drawings, wherein:

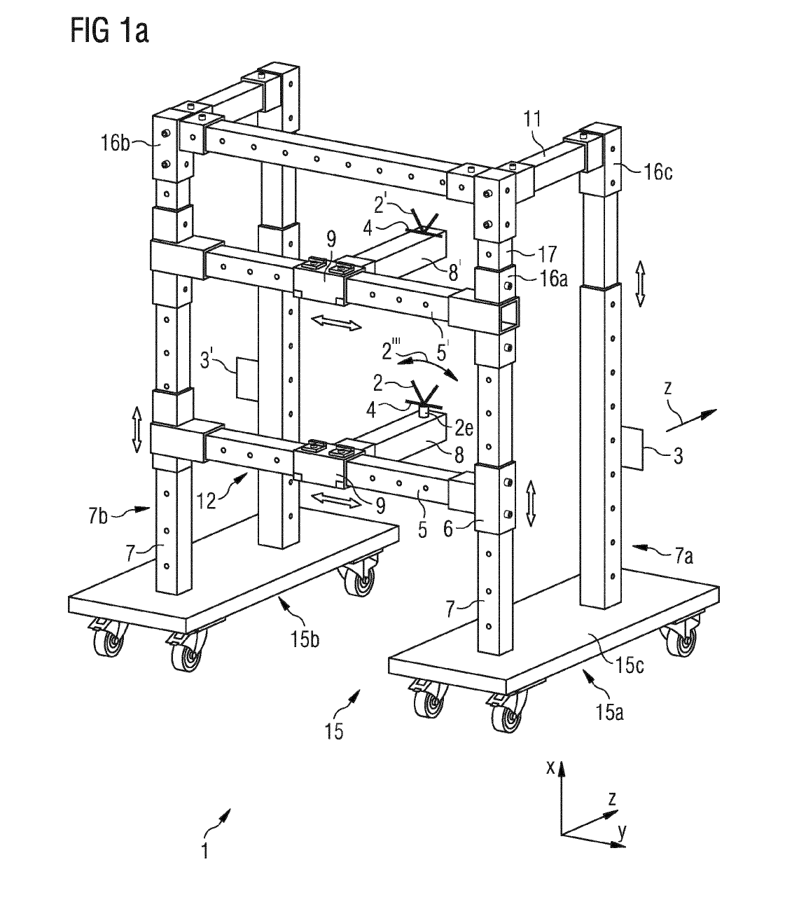

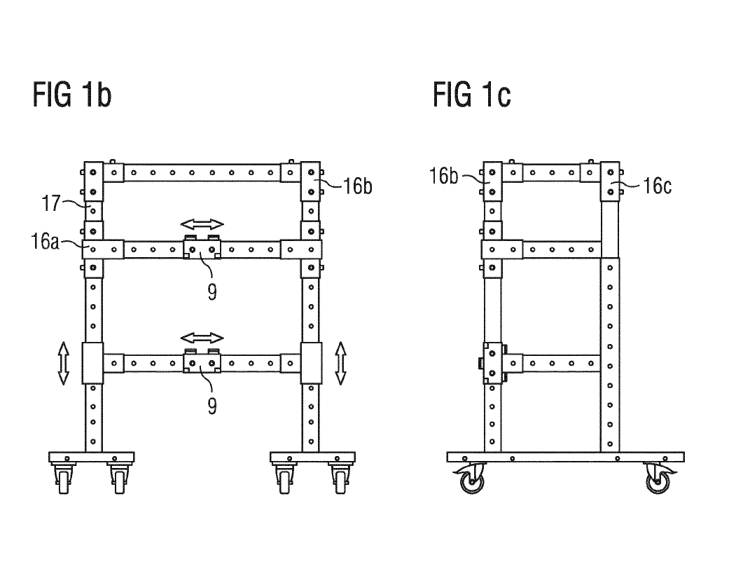

FIG. 1 shows a perspective view of a frame in accordance with the invention (FIG. 1a), and said frame in a rear view (FIG. 1b) and in a side view (FIG. 1c);

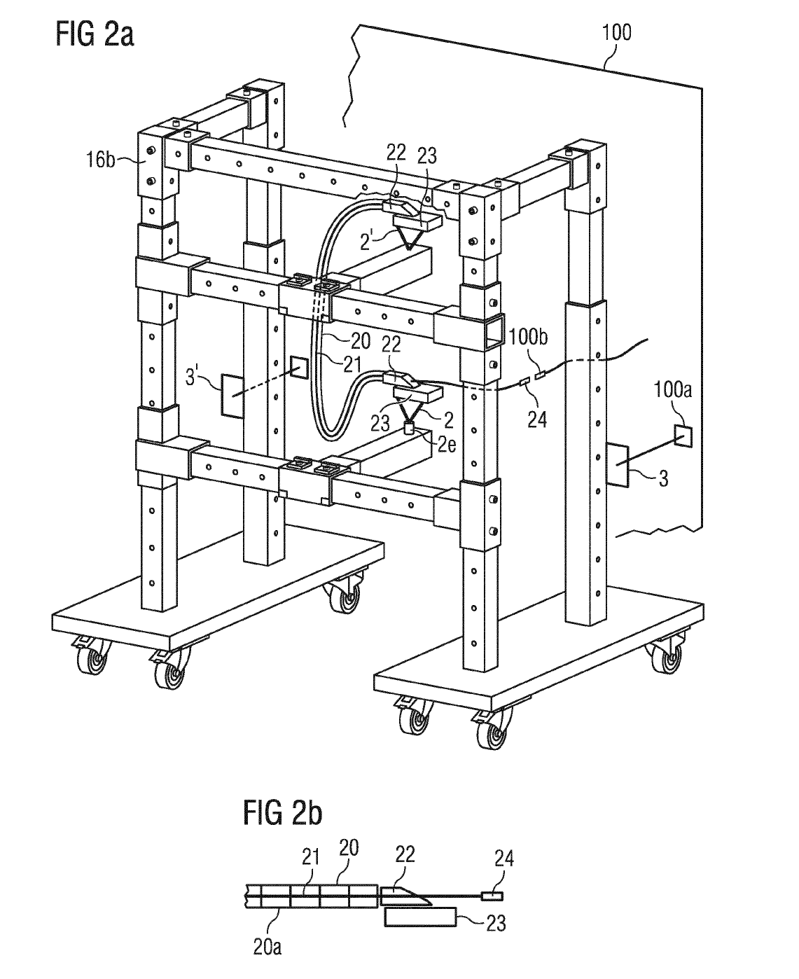

FIG. 2 shows a frame according to FIG. 1 in the docking position on a machine with machine connecting parts situated in their target position and with a line guide supply lines in its target position (FIG. 2a) and in a detailed view (FIG. 2b).

FIG. 1 shows a transport and mounting frame 1 in accordance with the invention for at least one supply line and/or line-guiding device 20 (with individual members 20a in this case), comprising at least one or several supply lines 21 (see FIG. 2). The frame is shown schematically in this case in order to illustrate the possible embodiments and components. Modifications for a functionally appropriate configuration are obvious to the person skilled in the art on the basis of the disclosure of the invention, wherein the frame can be arranged in different ways in individual cases in adjustment to the respective machine. The arrangement of the individual frame components or other components or devices can especially occur according to the claims. The respective description of the frame within the scope of the embodiments respectively also provides the respective measures with respect to the method in accordance with the invention.

The frame further comprises at least one retaining device 2 for retaining the supply line and/or line-guiding device in a spatially defined position, more precisely a retaining device for each end region of a line-guiding device to be fixed to an associated machine or, in the case of a free (non-guided) arrangement of a supply line (or a partial region of a line), one respective retaining device for this end region, i.e. two retaining devices in this case. This applies generally to each fastening region of the line or guide on the machine, which must be aligned for mounting on the machine, i.e. optionally also fastening regions of a guide which can be arranged between the end regions. The position of the line or line guide aligned on the frame and fixed with respect to its position is thus adjusted to an associated machine, so that the line or line guide can be fixed in a direct custom-fit manner to the machine, especially with respect to the position of the fastening regions (such as end fastening regions of the line guide or machine parts which retain such regions, and optionally also the connecting parts of the lines). For example, a different region of the line or line guide can be brought to its target position for the operation of the machine for reasons of limited space, e.g. a region between the end regions or the fastening regions of the line or line guide is to be folded to a target position for example.

Reference is made below to the line-guiding device as the preferred embodiment, but the same can optionally apply to a supply line.

The frame further comprises a docking device 3 for docking the frame with defined positioning by releasable fixing to the machine, on which the supply line and/or line guide is to be fixed as a part of the machine, e.g. in form of one or several flanges, guides and receivers of fastening bolts or struts of the machine or the like.

The retaining device 2 is attached to the frame in a manner to be adjustable in its location relative thereto and its position is changed for carrying out the method, so that the supply line or line-guiding device which is retained thereon can be or is arranged in several positions. Fastening means 4 such as fastening screws for fixing the retaining device and thus the line guide in several positions are provided and are actuated accordingly.

The retaining device or all retaining devices for fastening regions of the line or line guide on the machine to be aligned, e.g. for the end regions thereof, can be changed in their position in a continuous fashion (e.g. by suitable carriage or groove or spring guides), and can be fixed in their continuously selected positions with retained line guide to the frame by means of the fixing means 4, or are changed or fixed in their position for carrying out the method.

The retaining device 2 of at least one of the end regions 20 of the line guide can be changed in its position in a continuous fashion both in the X and Y direction independently from each other and can be fixed relative to the frame (or are changed in their position or fixed for carrying out the method), wherein the docking direction of the frame on the machine occurs in the Z direction. A height-adjustable crossbeam 5 or carriage is provided or actuated for this purpose, which can be fixed by means of the clamping device 6 in form of a clamping shoe for example, which clamping occurs in this case to the pillar 7 of the frame. The pillars 7 are used at the same time for guiding the clamping elements 6. A displaceable strut 8 is further arranged on the height-adjustable crossbeam 5, which strut can be or is fixed by means of a clamping device 9, e.g. in form of a fixable mounting buckle, in a selected position. This provides two independent degrees of freedom for adjustment. A further displaceable or positionally variable adjusting device, e.g. in form of a clamping shoe, a pivoting part or the like can optionally be arranged on the strut 8 (symbolised by the curved arrow 2′″), which carries the retaining device 2 in order to enable a further degree of freedom for adjustment, which is not shown here or not necessary due to the assigned machine. As a result of the displaceability in the longitudinal direction of the strut 8 or any other variability in the position, a variability in the position of the retaining device in the Z direction is provided (with associated separate fixing means); the Z direction generally corresponds in this case to the docking direction for moving the frame to the machine.

The further retaining device 2′ is arranged to be variable in its position in only one or two independent spatial directions (but optionally also in three spatial directions if required). The strut 8′ can be displaced longitudinally in a continuous fashion on the crossbeam 5′ and can be fixed by means of a fixing means such as a locking screw in a freely selected position relative to the frame. The retaining device can also be longitudinally displaceable with respect to the strut 8′, e.g. by means of a carriage or displaceable clamping shoe, so that two degrees of freedom concerning the position are thus provided. The crossbeam 5′ can also be arranged to be height-adjustable or it is height-adjustable, e.g. like the crossbeam 5, so that in this case three independent degrees of freedom concerning the position with respectively independent fixing means would also be provided for the second retaining device 2′.

The frame is arranged as a pillar construction with at least one pillar, which carries at least one transversely extending component such as a strut, crossbeam or carriage, on which at least one retaining device is or can be arranged on an end region or generally the fastening region of the line guide. According to the example, two retaining devices 2, 2′ are provided which are respectively fixed to a strut or crossbeam, which can be fixed on its part to at least one or several pillars.

The frame respectively comprises two laterally spaced pillar arrangements 7a, 7b, which are connected to each other by crossbeams 5. The pillar arrangement consists in this case of two respective pillars which are connected to each other by connecting struts 11. The pillars respectively form a yoke, on which the retaining device is arranged by means of further intermediate components.

At least one crossbeam 5 of the frame is arranged in a height-adjustable manner or is adjusted in its height, and comprises a transverse strut 8 on which the retaining device can be arranged. The transverse strut is displaceable in this case along a different strut or crossbeam, i.e. it is thus displaceable in a transverse direction in relation to the height adjustment of the crossbeam. As a result, the retaining device can thus be changed in its position in two directions, the X and Y direction, namely by the height adjustment of the carriage and displacement of the transverse strut. The frame thus comprises an orthogonal coordinate system as a result of the pillars and struts which are arranged orthogonally with respect to each other. A further retaining arm, which is also displaceably mounted on a transverse strut, can retain the second retaining device for retaining the second end region of the supply line or the line guide for the same.

At least the pillars arranged on the front side (facing the machine) are continuously height-adjustable in this case in the vertical direction in order to be usable in a universal fashion (preferably also the two rear ones in order to carry out a height adjustment of the frame).

The frame or the assembly of the frame thus comprises a carriage 12 which is height-adjustable or which has been height-adjusted according to the method (see vertical arrows), which is arranged by clamping means 6 on at least one pillar (two spaced pillars in this case) and can be fixed with a displacement range with any desired height adjustment. Clamping means are provided in this case for fixing, especially by a clamping bracket enclosing the pillar in part or in full.

All parts for positioning the retaining device which are displaceable or can be changed in their position can be fixed in their respective position. The two retaining devices can thus be moved or are moved independently from each other, and the two end regions of the supply line or line guide can be positioned or are positioned independently from each other spatially on the frame.

In accordance with the invention, the frame comprises a movable undercarriage 15, which is provided in this case in form of two separate travelling carriages 15a, 15b. Each of the carriages is equipped with wheels and at least three wheels, and precisely four wheels in this case, are preferably provided on each carriage, so that they can be installed in an inherently stable fashion. The frame or component group for the production of the same comprises at least one telescopic pillar 7, preferably one respective telescopic pillar on each travelling carriage. In particular, all the pillars of the frame are telescopic, i.e. height-adjustable (even if in this case only some of the pillars are shown as telescopic components). The undercarriage or travelling carriages 15a, 15b comprise a plurality of fastening points 15c for arranging the pillars in a positionally variable manner, i.e. in form of a hole matrix for accommodating fastening means for the pillars.

The struts or connecting struts (crossbeams) of the pillars (components 5, 8, 11) can be arranged in a telescopic or length-variable manner, or are actuated according to the positioning of the line/line guide, especially in such a way that at least two spaced pillars can be arranged with respect to each other and fixed with respect to their position by the telescoping and the variable distances (or are arranged and fixed with respect to their position), especially by fixing the telescopic device. Furthermore, the pillars arranged on a travelling carriage can be connected to each other by a telescopic or length-variable rod assembly. In order to allow the provision of different pillar arrangements, the displaceable subassembly of the frame comprises at least one carriage (two in this case) with a plurality of the spaced fastening points 15c for the pillars, which in this form allow a grid-like or continuous adjustability of the arrangement of the fastening points or pillars.

The frame further comprises pillars and/or connecting struts which can be extensible independently from each other by mounting elements 16 and extension elements 17. The mounting elements (connecting elements) can simultaneously represent intersecting points for fixing one or several further struts, e.g. in form of T-pieces 16a, corner connectors 16b, intersecting points with only two or with four, five or six connecting points or further mounting elements 16c, which are especially aligned in different spatial directions of a Cartesian coordinate system for example and allow extensions of the frame in these respective directions, preferably with respect to the individual directions independently from each other. The mounting elements are configured and arranged to dissipate loads. The mounting elements retain the extension elements in the manner of a plug-in connection for example and optionally also by a screwed connection or the like.

It is understood that the respective pillars can also be arranged by a combination of telescopic pillar parts with respective extensions, e.g. by inserted T-pieces or corner connectors. Two of the frame pillars are shown in a non-telescopic way in this case in order to illustrate the modifications of constructional possibilities.

The frame 1 can optionally also comprise further devices which enable pivoting or twisting of the retaining device or are actuated accordingly. As a result, one, both or all retaining devices can respectively be fixed to retaining arms that are mounted in a pivotable or twistable way.

The two end regions (or generally the fastening regions of the same) of the line guide 20 are provided in this case with (end) fastening members 22 or end fastening devices which are used for fixing the line guide to the machine. The same can be provided for the supply lines, which are provided and mounted without the line guide or partly outside of the line guide on the machine. The end fastening regions 22 are mostly fixed or to be fixed to machine parts 23 (FIG. 2), which can be dismountable from the machine. The machine parts are already retained or fixed here on the frame in their spatial target position for mounting on the machine. The fastening means can preferably act on the (mostly metal and therefore heavy) machine parts, and/or also on the end fastening parts of the line guide. Furthermore, the supply lines arranged in the line guide are already provided with its connecting parts 24 such as plugs, sockets etc for coupling to the connecting parts of the supplier and consumer of the machine (i.e. to media such as electric power, fluid etc to be supplied to or discharged from machine components). The two adjacent pillars on each of the carriages respectively form a yoke.

The retaining device 2 is displaceable or is displaced in this case by a drive 2e in order to move the retaining device away from the line or line guide after the fastening of the supply line or the line guide to the machine. The drive can be affixed to the retaining device or any other component of the frame that can change its position, and can be coupled to the strut 8 or a crossbeam 5 or a carriage for its displacement.

FIG. 2 further shows a machine 100 with machine docking devices 100a, to which the frame 1 is or was coupled, wherein the machine parts are fixed in this position to the machine and the connecting parts 24 of the supply line (arranged here in the line guide) are coupled to the connecting part 100b of the machine so as to enable the transfer of media. The frame can or is moved away, optionally after actuating the drive 2e, for distancing the retaining device from the line. For this purpose, the docking devices are removed from the frame and the machine.

A group of components which comprises the components of the frame according to the embodiment as a subassembly, wherein the subassembly comprises fewer components than the group, is arranged in the dismounted state on a movable, especially displaceable, transport device. The transport device can be arranged for example in the manner of a displaceable table frame or transport container.

The statements made above respectively also provide the handling of the transport and mounting frame in accordance with the invention as well as the performance of the method for mounting the supply line to the machine by means of the frame.

A transport and mounting frame is thus provided in accordance with the invention, and the supply line or line-guiding device with at least one supply line is transported and/or mounted on the machine by means of the transport and mounting frame in accordance with the invention. The retaining device for the supply line or line-guiding device (hereinafter “the line guide”) was attached to the frame relative to the same in a positionally variable manner, wherein the supply line or line guide can be arranged in several positions relative to the frame and can thus be aligned with respect to its target mounting position, and the supply line or line-guiding device is aligned in its target position on the frame in accordance with the method by changing the position of the position-variable components of the retaining device, wherein the alignment of the components of the retaining device occurs before or after or in a combined fashion before or after the fastening of the supply line or line guide to the retaining device. Furthermore, the fastening means provided on the frame for fixing the retaining device with the supply line or line guide arranged thereon in one of the several positions are fixed by means of the fastening means in a selected one of the several different positions, preferably in a position which corresponds to the target position or comes closest to this position among the selectable positions. The positionally variable retaining device is adjusted in its position on site on the machine and fixed in this position to the frame, so that the frame adjusted in this manner to the respective machine configuration is equipped with the respective supply line or line guide directly at another location, e.g. at the location of the respective manufacturer or supplier. The equipped frame is then docked by means of the docking device to the machine in order to fix the supply line or line guide to said machine. The project management effort is thus reduced substantially. A readjustment of the retaining device optionally occurs on site, which includes local fixing of the retaining device in the readjusted position by actuation, i.e. opening and closing, of the means respectively provided for adjustment or fixing, which means can be opened or closed as required several times in succession, e.g. for mounting a respective other line or line guide. The frame in accordance with the invention can be used for transporting or mounting a different or other spatially configured supply line or line guide to a differently configured machine in that the retaining device is brought to different target position or the frame components are assembled into a new frame that is configured differently.

The mounting of a supply line or line-guiding device with at least one supply line on a machine thus occurs in such a way that the supply line and/or line-guiding device is provided with at least one supply line on a frame in accordance with the invention arranged in a spatially defined position, wherein subsequently the frame is releasably fixed to the machine by means of the docking device, the at least one supply line is coupled to the machine, preferably to the consumer and/or supplier of the machine corresponding with the supply line, and the frame is dismounted from the supply line and the machine while the supply line remains coupled to the machine.

The coupling of the supply line to the corresponding consumer and/or supplier is carried out as a coupling that enables the transfer of media through the supply line.

Direct fixing of the frame to the machine occurs preferably. The used frame can be freely erected independently of the machine. The machine can be freely erected independently of the frame, generally within the scope of the invention, and can be actuated irrespective of the frame as required by conducting media through the supply line.

Instead of a releasable fixing of the frame to the machine, the frame can optionally also alternatively be fixed to a device which is preferably arranged in a stationary manner relative to the machine, e.g. a scaffold or part of a machine hall erected adjacent to the machine, a machine retainer or foundation or base or the like, in so far as such a connection allows a preferably media-transferring coupling of the supply line to the consumer and/or supplier corresponding with the supply line.

1. A transport and mounting frame for at least one supply line or line-guiding device, comprising at least one or more supply lines, wherein the frame comprises at least one retaining device for retaining the supply line and/or line-guiding device in a spatially defined position, and wherein the frame comprises a docking device for the positionally defined docking of the frame to a machine, to which machine the supply line and/or line guide is to be fastened as part of the machine, characterized in that the retaining device is attached to the frame in such a way that the position of the retaining device relative to the frame can be changed, so that the supply line or line-guiding device which is retained thereon can be arranged in several positions, and fastening means are provided for fixing the retaining device and thus the line guide in the several positions.

2. A frame according to claim 1, characterized in that the position of the retaining device can be changed in a continuous fashion, and can be fixed in said continuously selected positions with retained line guide to the frame by means of the fastening means.

3. A frame according to claim 1, characterized in that the retaining device(s) of at least one or both end regions of the supply line or line guide can be changed in their position in a continuous fashion independently from each other in two independent directions, and can be fixed.

4. A frame according to claim 1, characterized in that the retaining devices for one or both of the retaining devices of the line guide are independently adjustable in a continuous manner with respect to the frame in three directions (X and Y and Z direction) and can be fixed independently from each other in said directions.

5. A frame according to claim 1, characterized in that all pillars extending in the vertical direction and/or all transverse struts which connect the vertical pillars to each other and extend in a direction transversely to the docking direction of the frame are telescopic.

6. A frame according to claim 1, characterized in that the retaining device is retained on a carriage, comprising fixing means for fixing the position of the carriage in a target position.

7. A frame according to claim 1, characterized in that the retaining device comprises a pivotably and/or twistably mounted retaining element for retaining the supply line or the line guide in different, pivoting and/or twisting positions, or is pivotably and/or twistably mounted, and fixing means are provided for fixing the position of the retaining element with a line guide coupled thereto in a selected pivoting or twisting position.

8. A frame according to claim 1, characterized in that it comprises at least one or several telescopic struts.

9. A frame according to claim 1, characterized in that the fixing means are arranged as clamping means.

10. A frame according to claim 1, characterized in that the frame comprises at least one vertically and/or horizontally arranged strut, and one respective load-dissipating connectable extension element for said strut.

11. A frame according to claim 1, characterized in that several vertical pillars are provided which carry the retaining device and which are fastened to a base plate in a positionally variable manner.

12. A frame according to claim 1, characterized in that two laterally spaced pillars are provided which are connected by means of a crossbeam and between which the retaining device is arranged, and the two pillars are respectively arranged on a separate travelling carriage.

13. A frame according to claim 12, characterized in that the travelling carriage respectively allows positionally variable fixing of the respective pillar.

14. A frame according to claim 1, characterized in that on fixing of the supply line or line guide to the machine it comprises a front side facing said machine and a rear side facing away from said machine, and the frame comprises on at least one side of the central plane a strut or pillar which is continuously height-adjustable in the vertical direction.

15. A frame according to claim 1, characterized in that it comprises a simple or double yoke on which the retaining devices are arranged.

16. A frame according to claim 1, characterized in that the retaining device comprises a drive for changing the position of said device, by means of which the retaining device can be spaced from the line or line guide after fixing of the supply line or the line guide to the machine.

17. A frame according to claim 1, characterized in that the connecting parts for media-transferring coupling of the supply lines of the associated machine are provided on the at least one supply line provided for fixing to the machine.

18. A frame according to claim 1, characterized in that it comprises one or several machine parts of the machine associated with the supply line or line guide to be fixed, wherein the machine parts are releasably fixed to the retaining devices of the frame for retaining the supply line or line guide.

19. A frame according to claim 18, characterized in that the at least one supply line is coupled to the machine part in a manner so as to enable the transfer of media.

20. A frame according to claim 1, characterized in that a supplier and/or a consumer with respect to the medium conducted by the supply line is not arranged on the transport and mounting frame.

21. A machine with a frame docked thereon or associated therewith according to claim 1 with the spatial arrangement of the supply line and/or line guide with supply line in its target position for mounting said supply line on the machine, wherein the machine comprises a supplier and/or a consumer with respect to the medium conducted by the supply line which is connectable or are connected by means of the supply line in a medium-transferring manner.

22. A machine according to claim 21 with docked frame and with a supply line coupled to the machine, optionally as a part of the line guide, for the line-guiding connection of devices of the machine to each other by means of the coupled supply lines.

23. A machine according to claim 21, characterized in that the machine comprises an installation and/or retaining device for the spatial positioning of the machine, which device is independent of the transport and mounting frame.

24. A mobile, especially movable, transport device, comprising a predetermined number of components from which a predetermined subgroup of components are selectable, by means of which a transport and mounting frame can be set up according to claim 1.

25. A transport apparatus according to claim 24, characterized in that it comprises the following as components of the frame:
at least one travelling undercarriage;
a docking device for fixing the frame to machine;
at least one pillar;
at least one element in form of a strut, crossbeam or a carriage whose position can be changed with respect to the pillar and can be fixed in a selected position;
at least two retaining devices for fixing the two end regions of a supply line or line guide in a defined spatial arrangement thereof on the frame;
at least one means for the continuous change in the position and fixing of the retaining device in a selected position;
at least one supply line or line guide with supply line for the spatially defined retaining on the frame.

26. A method for mounting a supply line and/or line-guiding device with at least one supply line on a machine, characterized in that the supply line and/or line-guiding device with at least one supply line is provided in a spatially defined position on a frame according to claim 1, the frame is releasably fixed to the machine by means of the docking device, the at least one supply line is coupled to the machine, and the frame is dismounted from the supply line and the machine when the supply line is coupled to the machine.

27. A method according to claim 26, characterized in that after the dismounting of the frame from the machine the retaining device of the frame is brought to a different position relative to the frame for at least one further supply device, so that the further supply line retained on the retaining device is arranged in a position that differs from the first supply line coupled previously by means of the same frame to the machine, and the retaining device in said other position is fixed by means of the fastening means for fixing the retaining device.
